(19) United States
(12) Patent Application Publication
(10) Pub. No.: US 2003/0210798 A1
(43) Pub. Date: Nov. 13, 2003

(54) Speaker control apparatus and speaker system

(76) Inventor: Takashi Ohyaba, Tokorozawa-shi (JP)

Correspondence Address: YOUNG & THOMPSON, 745 SOUTH 23RD STREET 2ND FLOOR, ARLINGTON, VA, 22202

(21) Appl. No.: 10/382,919

(22) Filed: Mar. 7, 2003

(30) Foreign Application Priority Data
Mar. 7, 2002 (JP) P2002-61536

(51) Int. Cl. H04R 3/00; H04B 15/00

(52) U.S. Cl. 381/96; 381/93; 381/83; 381/59

(57) ABSTRACT

There is provided a speaker control apparatus capable of efficiently improving frequency characteristic of a speaker apparatus of phase inversion type, which is originally small in size and high in efficiency. The speaker control apparatus includes a detection section for detecting sound pressure within a speaker apparatus of phase inversion type and generating a sound pressure signal Spo corresponding to the detected sound pressure, a signal processing section for generating a feedback signal Sfb for feedback on the basis of the detected sound pressure signal Spo, a feedback section for feeding back the feedback signal Sfb to an input signal corresponding to sound to be radiated and generating a feedback input signal Ssy, and an amplification section for driving a speaker unit included in the speaker apparatus on the basis of the feedback input signal Ssy and causing radiation of sound.

### BACKGROUND OF THE INVENTION

1. Field of the Invention

The present invention relates to a speaker control apparatus and a speaker system, and in particular to a speaker control apparatus for driving and controlling a speaker of phase inversion type, and a speaker system including such a speaker control apparatus.

2. Description of the Related Art

Typically, in order to improve the frequency characteristic of a speaker system, a frequency range having a flat output value is expanded to a low frequency region as far as possible.

As a conventional method for improving the output characteristic of such a low frequency band, the so-called MFB (Motional Feed-Back) system is used. In the MFB system, a motion state of a voice coil or a diaphragm in a speaker apparatus is detected by a direct detection section provided in the speaker apparatus and converted to an electric signal, and the electric signal is fed back to an input signal.

Besides the MFB system, a system in which sound pressure from a diaphragm is converted to an electric signal and the electric signal is fed back to an input signal, i.e., the so-called AFB (Automatic Feed-Back) system is also used.

In the case of the MFB system, however, control using the motion state of the voice coil or the diaphragm is conducted. This results in a problem that the MFB system can be applied to only a speaker apparatus of the so-called closed type in which the radiation characteristic of the speaker apparatus depends on only the motion state of the diaphragm. Since the speaker apparatus of closed type is low in efficiency, it is rarely used. This results in a problem that the MFB system itself is not typical.

On the other hand, in the case of the AFB system, the sound pressure from the diaphragm is detected and used for feedback. If synthetic sound pressure obtained by combining the sound pressure caused by radiation sound from the diaphragm and sound pressure caused by radiation sound from the duct is detected, then it can be applied to a speaker apparatus of the so-called bass-reflex type as well. In this case as well, however, it is necessary to dispose each microphone for sound pressure detection in a position that is outside an enclosure of the speaker apparatus and equally distant from the speaker and the duct. Since the microphone is disposed outside the enclosure, even sound pressure caused by external noise other than the radiation sound from the diaphragm and radiation sound from the duct is detected. The sound pressure caused by the external noise becomes a noise component. This results in a problem that the control of the frequency characteristic becomes difficult in some cases.

Besides them, it has also been attempted to apply the MFB system to the speaker apparatus of phase inversion type by using the so-called passive corn instead of the duct, disposing a velocity detector or an acceleration detector in each of the diaphragm and the passive corn, combining signals corresponding to the velocity or acceleration, and feeding back a resultant synthetic signal to the input signal. In the case of this configuration, however, there is a problem that the whole configuration becomes complicated and the manufacturing cost becomes high.

### SUMMARY OF THE INVENTION

In view of the above-described problems, the present invention has been made. An object of the present invention is to provide a speaker control apparatus capable of efficiently improving frequency characteristic of a speaker apparatus of phase inversion type, which is originally small in size and high in efficiency, and a speaker system including such a speaker control apparatus.

The above object of the present invention can be achieved by a speaker control apparatus. The speaker control apparatus is provided with: a single sound pressure detection device for detecting sound pressure in a speaker apparatus of phase inversion type and generating a sound pressure signal corresponding to the detected sound pressure; a generation device for generating a feedback signal for feedback on the basis of the generated sound pressure signal; a feedback device for feeding back the generated feedback signal to an input signal corresponding to sound to be radiated and generating a feedback input signal; and a driving device for driving a speaker included in the speaker apparatus on the basis of the feedback input signal.

According to the speaker control apparatus, the sound pressure detection device detects the sound pressure within the speaker apparatus of phase inversion type and generates the corresponding sound pressure signal, and the feedback signal generated on the basis of the sound pressure signal is fed back to the input signal to drive the speaker. Therefore, the frequency characteristic of the sound radiated to the outside of the speaker apparatus can be improved.

In one aspect of the speaker control apparatus, wherein the sound pressure detection device detects sound pressure inside an enclosure included in the speaker apparatus, and generates the sound pressure signal corresponding to the detected sound pressure, the generation device outputs the sound pressure signal intactly as the feedback signal, and the feedback device conducts positive feedback of the output sound pressure signal to the input signal and generates the feedback input signal.

According to this aspect, the sound pressure of the inside of the enclosure is detected and the corresponding sound pressure signal is intactly and positively fed back to the input signal to drive the speaker. As a result, the equivalent stiffness in the vibration system of the speaker can be decreased. Therefore, the low frequency band part in the frequency characteristic of the sound radiated from the speaker can be improved.

In another aspect of the speaker control apparatus, wherein the sound pressure detection device detects sound pressure inside an enclosure included in the speaker apparatus, and generates the sound pressure signal corresponding to the detected sound pressure, the generation device generates a differential sound pressure signal by differentiating the sound pressure signal, and outputs the generated differential sound pressure signal as the feedback signal, and the feedback device conducts feedback of the output differential sound pressure signal to the input signal and generates the feedback input signal.

According to this aspect, the sound pressure of the inside of the enclosure is detected and the differential sound pressure signal obtained by differentiating the corresponding sound pressure signal is fed back to the input signal to drive the speaker. As a result, it becomes possible to control the characteristic of the vibration system of the speaker. Therefore, the low frequency band part in the frequency characteristic of the sound radiated from the speaker can be improved.

In further aspect of the speaker control apparatus, wherein the generation device generates the differential sound pressure signal by differentiating the sound pressure signal once, and outputs the generated differential sound pressure signal as the feedback signal.

According to this aspect, the sound pressure of the inside of the enclosure is detected and the differential sound pressure signal obtained by differentiating the corresponding sound pressure signal once is fed back to the input signal to drive the speaker. As a result, it becomes possible to control the mechanical resistance in the vibration system of the speaker. Therefore, it is possible to control the braking action in resonance and improve the low frequency band part in the frequency characteristic of the sound radiated from the speaker.

In further aspect of the speaker control apparatus, wherein the generation device generates the differential sound pressure signal by differentiating the sound pressure signal twice, and the feedback device conducts negative feedback of the generated differential sound pressure signal to the input signal and generates the feedback input signal.

According to this aspect, the sound pressure of the inside of the enclosure is detected and the differential sound pressure signal obtained by differentiating the corresponding sound pressure signal twice is negatively fed back to the input signal to drive the speaker. As a result, the mass in the vibration system of the speaker can be increased. Therefore, the low frequency band part in the frequency characteristic of the sound radiated from the speaker unit can be improved.

In further aspect of the speaker control apparatus, wherein the sound pressure detection device detects sound pressure inside an enclosure included in the speaker apparatus, and generates the sound pressure signal corresponding to the detected sound pressure, the sound pressure detection device comprises: a difference device for detecting a difference between the sound pressure signal and the input signal, and for generating a difference signal; a multiplication device for multiplying the difference signal by a preset feedback factor and generating a feedback difference signal; and an addition device for adding the generated feedback difference signal to the sound pressure signal and generating a addition sound pressure signal serving as the feedback signal, and the feedback device conducts positive feedback of the generated addition sound pressure signal to the input signal and generates the feedback input signal.

According to this aspect, the sound pressure inside the enclosure is detected and the feedback difference signal obtained by multiplying the difference between the corresponding sound pressure signal and the input signal by the feedback factor is added to the original sound pressure signal. The resultant addition sound pressure signal is positively fed back to the input signal. As a result, nonlinearity contained in the sound pressure signal can be suppressed, and consequently nonlinearity of the radiated sound can be decreased.

In further aspect of the speaker control apparatus, wherein the sound pressure detection device detects sound pressure within a duct included in the speaker apparatus, and generates the sound pressure signal corresponding to the detected sound pressure, and the generation device generates a differential sound pressure signal by differentiating the sound pressure signal, and outputs the generated differential sound pressure signal as the feedback signal.

According to this aspect, the sound pressure within the duct included in the speaker apparatus is detected and the corresponding sound pressure signal is differentiated and the resultant signal is fed back. As a result, the acoustic characteristic of the duct can be altered equivalently. Therefore, it is possible to control the acoustic characteristic of the duct and improve the frequency characteristic in the radiated sound without altering the physical structure of the duct.

In further aspect of the speaker control apparatus, wherein the generation device generates the differential sound pressure signal by differentiating the sound pressure signal once.

According to this aspect, the sound pressure within the duct included in the speaker apparatus is detected and the corresponding sound pressure signal is differentiated once and the resultant signal is fed back. As a result, the mechanical resistance of air in the duct can be changed equivalently. Therefore, it is possible to control the acoustic characteristic of the duct and improve the frequency characteristic in the radiated sound without altering the physical structure of the duct.

In further aspect of the speaker control apparatus, wherein the generation device generates the differential sound pressure signal by differentiating the sound pressure signal twice, and the feedback device conducts negative feedback of the generated differential sound pressure signal to the input signal and generates the feedback input signal.

According to this aspect, the sound pressure within the duct included in the speaker apparatus is detected and the corresponding sound pressure signal is differentiated twice and the resultant signal is negatively fed back. As a result, the mass of air in the duct can be increased equivalently. Therefore, it is possible to control the acoustic characteristic of the duct and improve the frequency characteristic in the radiated sound without altering the physical structure of the duct.

The above object of the present invention can be achieved by a speaker system. The speaker system is provided with: a speaker control apparatus including: a single sound pressure detection device for detecting sound pressure in a speaker apparatus of phase inversion type and generating a sound pressure signal corresponding to the detected sound pressure; a generation device for generating a feedback signal for feedback on the basis of the generated sound pressure signal; a feedback device for feeding back the generated feedback signal to an input signal corresponding to sound to be radiated and generating a feedback input signal; a driving device for driving a speaker included in the speaker apparatus on the basis of the feedback input signal; and the speaker apparatus.

According to the speaker system, the sound pressure detection device detects the sound pressure within the speaker apparatus of phase inversion type and generates the corresponding sound pressure signal, and the feedback signal generated on the basis of the sound pressure signal is fed back to the input signal to drive the speaker. Therefore, the frequency characteristic of the sound radiated to the outside of the speaker apparatus can be improved.

### BRIEF DESCRIPTION OF THE DRAWINGS

FIG. 1 is a first diagram showing a principle of the present invention;

FIG. 2 is a first diagram showing a principle of the present invention;

FIG. 3 is a block diagram showing a schematic configuration of a speaker system according to a first embodiment of the present invention;

FIG. 4 is a block diagram showing a schematic configuration of a speaker system according to a second embodiment of the present invention;

FIG. 5A is a block diagram showing a first example of schematic configurations of a speaker system according to a third embodiment of the present invention.

FIG. 5B is a block diagram showing a second example schematic configurations of a speaker system according to a third embodiment of the present invention.

### DESCRIPTION OF THE PREFERRED EMBODIMENTS

Preferred embodiments of the present invention will now be described with reference to the drawings.

Embodiments hereafter described are embodiments in the case where the present invention is applied to a speaker control apparatus for driving and controlling a speaker apparatus of phase inversion type having a duct (hereafter referred to as speaker apparatus of bass-reflex type).

(I) Principle of the Present Invention

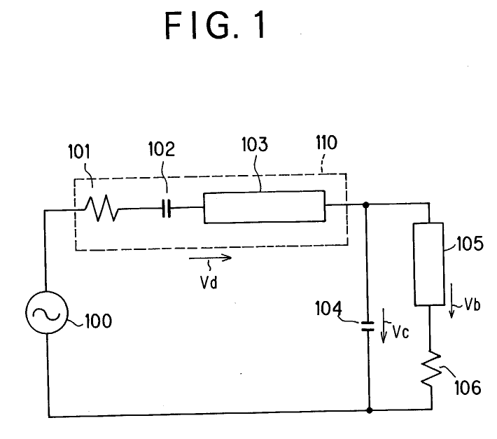

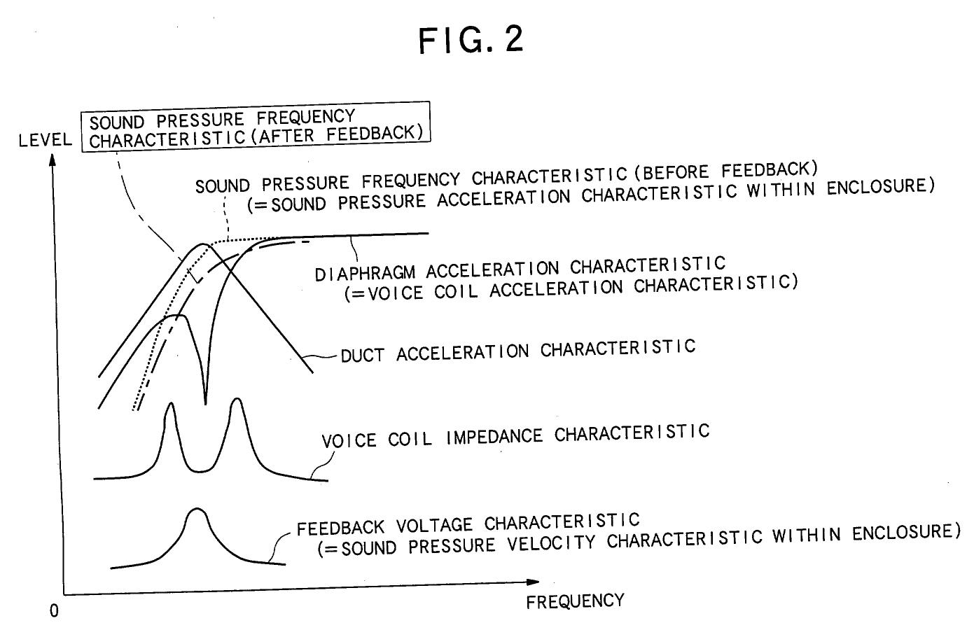

Prior to description of concrete embodiments, the principle of the present invention will first be described with reference to FIGS. 1 and 2. FIG. 1 is a diagram showing a mechanical equivalent circuit of a speaker apparatus of bass-reflex type. FIG. 2 is a diagram showing how the frequency characteristic is improved when one of principles described hereafter is used.

When driving force (also referred to as exciting force or vibromotive force) F for driving a voice coil in a speaker unit included in a speaker apparatus, a mechanical equivalent circuit showing operation of a speaker apparatus of bass-reflex type typically becomes as shown in FIG. 1. The driving force F (N (Newton)) is obtained by multiplying a magnetic flux density B (Wb/m²) in a magnetic gap in which the voice coil included in the speaker unit is inserted by a length L (m) of a conductor wound as the voice coil, and further multiplying a resultant product by a current i (A) flowing through the voice coil.

As shown in FIG. 1, the equivalent circuit includes mechanical impedance 110 of the speaker unit. The mechanical impedance 110 in turn includes mechanical resistance 101 in the speaker unit, compliance 102 of a suspension (i.e., a spring for restoration of the voice coil), and an equivalent mass 103 of the speaker unit. The equivalent circuit further includes driving force 100, compliance 104 of an enclosure (i.e., casing of the speaker apparatus) to which the speaker apparatus is attached, a mass 105 of air flowing in a duct, and resistance 106 of the air.

Denoting in the equivalent circuit shown in FIG. 1 density of air by ρ (kg/m³), a distance between a microphone placed in front of the speaker unit and a diaphragm by r (m), a velocity of the diaphragm by Vd (m/second), a traveling velocity of air in the enclosure by Vc (m/second), a traveling velocity of air in the duct by Vp (m/second), and an area of the diaphragm by S (m²), sound pressure P (N/m²) of sound radiated to the outside is represented by the following equation.

$$P = \frac{ρ ω}{4 π r} \times ( Vd + ( - Vp ) ) \times S = \frac{ρ ω}{4 π r} \times Vc \times S \qquad ( 1 )$$

The equation (1) represents the frequency characteristic of sound pressure in the speaker apparatus represented by the equivalent circuit shown in FIG. 1.

It will be appreciated from the equation (1) that the frequency characteristic of the sound pressure in the speaker apparatus of bass-reflex type is proportionate to a volume acceleration obtained by differentiating a volume velocity (i.e., a quantity represented by Vc×S in the equation (1)) of air in the enclosure. Therefore, it will be appreciated that it becomes possible to control the sound pressure frequency characteristic of the radiated sound by detecting sound pressure in the enclosure, converting the detected sound pressure to a signal indicating the traveling velocity of air in the enclosure and a signal indicating an amplitude in the travel of the air, and feeding back the signals to an input signal.

Denoting a feedback signal obtained when an input signal Ei corresponding to a sound to be radiated is input from the outside by Ef, the equation (1) can be modified as represented by the following equation.

$$\begin{matrix}P = \frac{ρ ω}{4 π r} \times \frac{Y \times ( Ei + Ef ) \times BL \times S}{Rv \{ j ω mo - j ( 1 / ω cs + 1 / ω cc + Y / ω cc ) + {BL}^{2} / Rv + rm \}} \\ where Y = \frac{j ω cc \times r p - {ω}^{2} m p \times cc}{j ω cc \times r p + 1 - {ω}^{2} m p \times cc}\end{matrix} \qquad ( 2 )$$

In the equation (2), “rm” is the value of the mechanical resistance 101 (N·second/m), “cs” the value of the compliance (m/N), “mo” the value the equivalent mass 103 (kg), “zm” the value of the mechanical impedance 110, cc the value of the compliance 104 (m/N), “mp” the value of the mass 105 (kg), “rp” the value of the resistance 106 (N·second/m), and “Rv” the value of electric resistance of the voice coil (Ω).

When as a first principle, an electric signal proportionate to the volume acceleration obtained by differentiating the value Vc of the volume velocity in the enclosure in the equation (2) once is negatively fed back (i.e., when the negative feedback of acceleration is conducted and the value of the feedback signal Ef becomes equal to “−KjωVc)”, the following equation is obtained.

$$P = \frac{ρ ω}{4 π r} \times \frac{Y \times Ei \times BL \times S}{Rv \{ j ω ( mo + YKBL / Rv ) - j ( 1 / ω cs + 1 / ω cc + Y / ω cc ) + {BL}^{2} / Rv + rm \}} \qquad ( 3 )$$

From the equation (3), the acceleration negative feedback processing becomes equivalent to an increase in the value of the mass (kg) in the speaker apparatus by “YKBL/Rv”. It will be appreciated that as a result the frequency characteristic in the low frequency band at the sound pressure P is improved (i.e., the frequency band in which the sound pressure level becomes flat extends to the lower frequency side).

As a matter of fact, it is difficult in the acceleration negative feedback to directly detect the volume velocity Vc and convert it to an electric signal. Therefore, the sound pressure P in the enclosure is detected by the microphone, and a signal obtained by differentiating the sound pressure P in the enclosure twice is negatively fed back to the input signal Ei as the feedback signal Ef.

When as a second principle, an electric signal proportionate to the volume amplitude obtained by integrating the value Vc of the volume velocity in the enclosure in the equation (2) is positively fed back (i.e., when the positive feedback of amplitude is conducted and the value of the feedback signal Ef becomes equal to “KVc/jω”), the following equation is obtained.

$$P = \frac{ρ ω}{4 π r} \times \frac{Y \times Ei \times BL \times S}{Rv \{ j ω m o - j ( 1 / ω cs - YKBL / Rv / ω + 1 / ω cc + Y / ω cc ) + {BL}^{2} / Rv + rm \}} \qquad ( 4 )$$

From the equation (4), the amplitude positive feedback processing becomes equivalent to a decrease in the value of the equivalent stiffness (N/m) of a vibration system in the speaker apparatus by “YKBL/Rv”. It will be appreciated that as a result the frequency characteristic in the low frequency band at the sound pressure P is improved.

In the case of the acceleration positive feedback as well, the volume velocity Vc is not directly detected, but the sound pressure P (which corresponds to the volume amplitude itself) in the enclosure is detected by the microphone, and it is intactly and positively fed back to the input signal Ei as the feedback signal Ef.

When as a third principle, an electric signal proportionate to the value Vc of the volume velocity in the enclosure in the equation (2) is negatively fed back (i.e., when the negative feedback of velocity is conducted and the value of the feedback signal Ef becomes equal to “−KVc”), the following equation is obtained.

$$P = \frac{ρ ω}{4 π r} \times \frac{Y \times Ei \times BL \times S}{Rv \{ j ω mo - j ( 1 / ω cs + 1 / ω cc + Y / ω cc ) + {BL}^{2} / Rv + rm + YKBL / Rv \}} \qquad ( 5 )$$

From the equation (5), the velocity negative feedback processing becomes equivalent to an increase in the value of the mechanical resistance of the vibration system in the speaker apparatus by “YKBL/Rv”. Braking action of the resonance frequency in the vibration system can be thus increased. It will be appreciated that as a result sharpness Q of resonance in the low frequency band can be reduced.

A simulation result of a change of the frequency characteristic of each physical quantity obtained when the equation (5) is used is shown in FIG. 2. As appreciated from FIG. 2, sharpness Q in the low frequency band is reduced after the velocity negative feedback.

If in the case of the equation (5) a feedback signal Ef is positively fed back, i.e., velocity positive feedback processing is conducted, then the sign of the mechanical resistance in the equation (5) is inverted. In this case, therefore, the velocity positive feedback processing becomes equivalent to a decrease of the value of the mechanical resistance by “YKBL/Rv”. Braking action of the resonance frequency in the vibration system can be thus reduced. It will be appreciated that as a result sharpness Q of resonance in the low frequency band can be increased.

In the case of the velocity negative feedback as well, the volume velocity Vc is not directly detected, but the sound pressure P (which corresponds to the volume amplitude itself) in the enclosure is detected by the microphone, and a signal obtained by differentiating the sound pressure P once is negatively fed back to the input signal Ei as the feedback signal Ef.

(II) First Embodiment

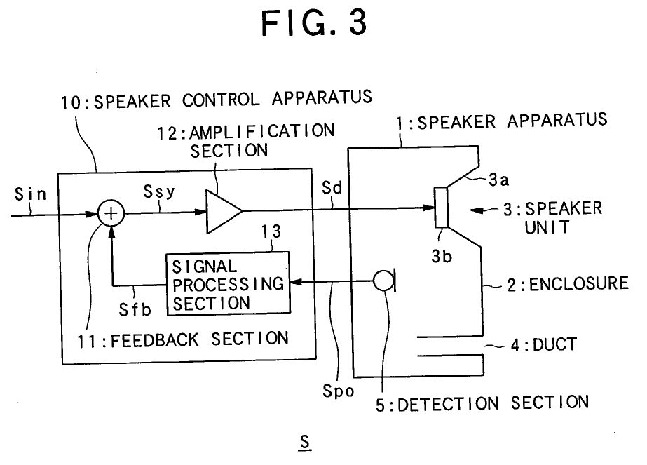

A first embodiment according to the present invention will now be described with reference to FIG. 3.

FIG. 3 is a block diagram showing a schematic configuration of a speaker system according to the first embodiment.

As shown in FIG. 3, a speaker system S of the first embodiment includes a speaker control apparatus 10 and a speaker apparatus 1 of bass-reflex type.

The speaker apparatus 1 includes an enclosure 2 serving as a casing, and a speaker unit 3. The speaker unit 3 is disposed on a surface of the enclosure 2 in a radiation direction (a rightward direction in FIG. 3), and the speaker unit 3 includes a diaphragm 3a and a voice coil 3b. The speaker apparatus 1 further includes a duct 4. The duct 4 inverts the phase of sound radiated in a rear direction of the speaker unit 3 (inward direction of the enclosure 2), and radiates it in the radiation direction. The speaker apparatus 1 further includes a detection section 5 serving as a sound pressure detection device and including a microphone or the like. The detection section 5 detects sound pressure in the enclosure 2, generates a corresponding sound pressure signal Spo, and outputs the sound pressure signal Spo to the speaker control apparatus 10.

The speaker control apparatus 10 includes a feedback section 11 serving as a feedback device. The feedback section 11 adds an input signal Sin (having the value Ein) input from the outside and a feedback signal Sfb described later, and generates a feedback input signal Ssy. The speaker control apparatus 10 further includes an amplification section 12 serving as a driving device for amplifying the feedback signal Sfb with a preset amplification factor, generating a driving signal Sd, outputting the driving signal Sd to the speaker unit 3, and driving the speaker unit 3. The speaker control apparatus 10 further includes a signal processing section 13 serving as a generation device for conducting processing described later on the sound pressure signal Spo supplied from the detection section 5 and generating the feedback signal Sfb.

Operations of the signal processing section 13 based on the three principles will now be described.

In the case where the signal processing section 13 functions on the basis of the first principle and conducts the acceleration negative feedback processing on the input signal Sin, the signal processing section 13 differentiates the sound pressure signal Spo twice, inverts a resultant signal in polarity, and outputs a resultant signal to the feedback section 11 as the feedback signal Sfb. As a result, the acceleration negative feedback processing is conducted on the input signal Sin, and the frequency characteristic of the sound pressure P in the low frequency band is improved on the basis of the equation (3).

In the case where the signal processing section 13 functions on the basis of the second principle and conducts the amplitude positive feedback processing on the input signal Sin, the signal processing section 13 outputs the sound pressure signal Spo as it is to the feedback section 11 as the feedback signal Sfb. As a result, the amplitude positive feedback processing is conducted on the input signal Sin, and the frequency characteristic of the sound pressure P in the low frequency band is improved on the basis of the equation (4).

In the case where the signal processing section 13 functions on the basis of the third principle and conducts the velocity negative feedback processing on the input signal Sin, the signal processing section 13 differentiates the sound pressure signal Spo once, inverts a resultant signal in polarity, and outputs a resultant signal to the feedback section 11 as the feedback signal Sfb. As a result, the acceleration negative feedback processing is conducted on the input signal Sin, and it becomes possible to control the sharpness of resonance of the sound pressure P in the low frequency band on the basis of the equation (5).

As described above, according to the operation of the speaker control apparatus 10 in the first embodiment, the detection section 5 detects the sound pressure within the speaker apparatus 1 of bass-reflex type and generates the corresponding sound pressure signal Spo, and the feedback signal Sfb generated on the basis of the sound pressure signal Spo is fed back to the input signal Sin to drive the speaker unit 3. Therefore, the frequency characteristic of the sound radiated to the outside of the speaker apparatus 1 can be improved.

In the case based on the first principle, the sound pressure of the inside of the enclosure 2 is detected and the feedback signal Sfb obtained by differentiating the corresponding sound pressure signal Spo twice is negatively fed back to the input signal Sin to drive the speaker unit 3. As a result, the mass in the vibration system of the speaker unit 3 can be increased. Therefore, the low frequency band part in the frequency characteristic of the sound radiated from the speaker unit 3 can be improved.

In the case based on the second principle, the sound pressure of the inside of the enclosure 2 is detected and the corresponding sound pressure signal Spo is intactly and positively fed back to the input signal Sin to drive the speaker unit 3. As a result, the equivalent stiffness in the vibration system of the speaker unit 3 can be decreased. Therefore, the low frequency band part in the frequency characteristic of the sound radiated from the speaker unit 3 can be improved.

In the case based on the third principle, the sound pressure of the inside of the enclosure 2 is detected and the feedback signal Sfb obtained by differentiating the corresponding sound pressure signal Spo once is negatively fed back to the input signal Sin to drive the speaker unit 3. As a result, the mechanical resistance in the vibration system of the speaker unit 3 can be increased. Therefore, it becomes possible to control the braking action in resonance and improve the low frequency band part in the frequency characteristic of the sound radiated from the speaker unit 3.

Therefore, the frequency characteristic in a small-sized speaker apparatus of phase inversion type can be improved efficiently.

The first embodiment has been described supposing that the speaker control apparatus 10 and the speaker apparatus 1 are separate from and independent of each other. However, the speaker control apparatus 10 may be disposed within the speaker apparatus 1. It is also possible to dispose the speaker control apparatus 10 in a position at a distance from the speaker apparatus 1 and control the operation of the speaker apparatus 1 in this state.

As for the first embodiment, the operation in the case of each of the acceleration negative feedback processing, the velocity negative feedback processing, and the amplitude positive feedback processing has been described as each of the three principles. Besides them, however, the feedback signal Sfb may be generated as the acceleration positive feedback processing, the velocity positive feedback processing, or the amplitude negative feedback processing so as to approach the desired frequency characteristic of the speaker apparatus 1.

In addition, it is also possible to combine the above described kinds of processing.

(III) Second Embodiment

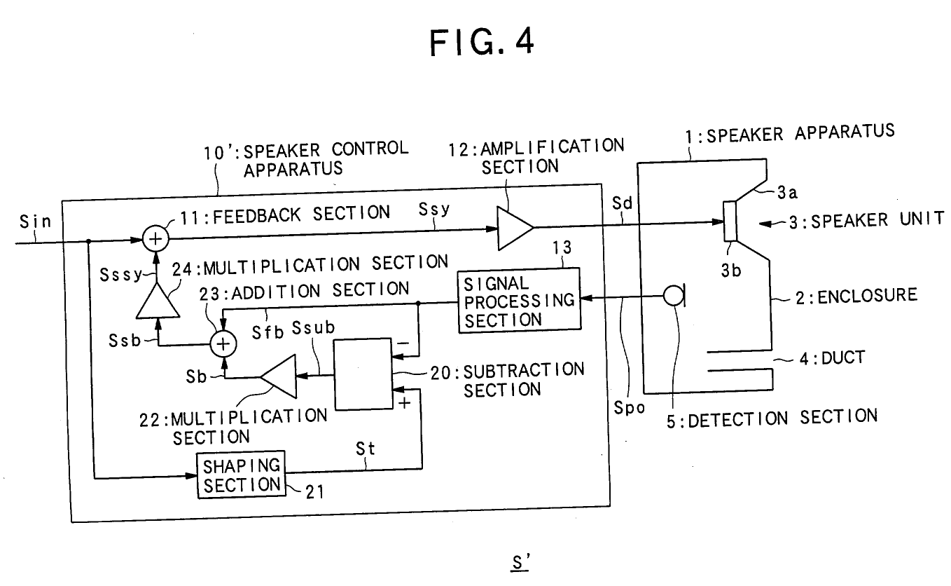

A second embodiment according to the present invention will now be described with reference to FIG. 4.

FIG. 4 is a block diagram showing a schematic configuration of a speaker system according to the second embodiment.

In the first embodiment, the feedback signal Sfb generated on the basis of one of the three principles is output intactly to the feedback section 11. In the second embodiment described hereafter, however, distortion contained in the feedback signal Sfb, if any, is removed and then fed back.

As shown in FIG. 4, a speaker system S′ of the second embodiment includes a speaker apparatus 1 having a configuration similar to that of the first embodiment, and a speaker control section 10′ of the second embodiment.

Besides the feedback section 11, the amplification section 12, and the signal processing section 13, the speaker control section 10′ includes a subtraction section 20 as a difference device, a shaping section 21, a multiplication section 24, a multiplication section 22 serving as a multiplication device, and an addition section 23 serving as an addition device.

Operation will now be described.

The shaping section 21 multiplies the input signal Sin by a linear transfer function corresponding to a desired frequency characteristic that the speaker apparatus 1 should have, thus generates a processing input signal St, and outputs the processing input signal St to an addition terminal of the subtraction section 20.

On the other hand, a feedback signal Sfb generated in the same way as the first embodiment is output to a subtraction terminal of the subtraction section 20 and the addition section 23.

As a result, the subtraction section 20 subtracts the feedback signal Sfb from the processing input signal St, inverts a resultant difference signal, generates a subtraction signal Ssub, and outputs the subtraction signal Ssub to the multiplication section 22.

The multiplication section 22 multiplies the subtraction signal Ssub by a feedback factor preset so as to correspond to the transfer function multiplied in the shaping section 21, thus generates a feedback factor multiplication signal Sb, and outputs the feedback factor multiplication signal Sb to the addition section 23.

As a result, the addition section 23 adds the feedback signal Sfb and the feedback factor multiplication signal Sb (i.e., subtracts a signal obtained by multiplying the signal resulting from subtraction of the feedback signal Sfb from the processing input signal St by the feedback factor, from the feedback signal Sfb), thus generates a processing signal Ssb, and outputs the processing signal Ssb to the multiplication section 24.

The multiplication section 24 multiplies the processing signal Ssb by another feedback factor preset so as to correspond to the transfer function multiplied in the shaping section 21, thus generates a multiplication feedback signal Sssy, and outputs the multiplication feedback signal Sssy to the feedback section 11.

Thereafter, the feedback section 11 feeds back the multiplication feedback signal Sssy to the input signal Sin on the basis of each of the principles in the first embodiment, thus generates the feedback input signal Ssy, and outputs the feedback input signal Ssy to the amplification section 12.

Processing executed in the subtraction section 20, the shaping section 21, the multiplication sections 22 and 24, and the addition section 23 will now be described collectively. Denoting a voltage of the input signal Sin by Ei, a voltage of the multiplication feedback signal Sssy by Ef, a voltage of the feedback input signal Ssy in the second embodiment by E, a voltage of the sound pressure signal Spo by Ep, feedback factors multiplied in the multiplication sections 22 and 24 respectively by α and β, a transfer function between an input part of the amplification section 12 and (an input part of) the detection section 5 by T (=Ep/E), and a transfer function multiplied in the shaping section 21 by T0, the following relation is obtained.

$$E p = \frac{T ( 1 + α β T o )}{1 + T β ( α - 1 )} \times E i \qquad ( 6 )$$

If the feedback factor α is sufficiently greater than 1 in the equation (6), then the equation (6) becomes as represented by the following equation.

Ep≈E×T0 (7)

It becomes possible to execute necessary feedback processing while neglecting distortion, if any, contained in the transfer function T.

As heretofore described, according to the operation of the speaker system S′ in the second embodiment, the sound pressure inside the enclosure 2 is detected and the multiplication feedback signal Sssy generated on the basis of the corresponding sound pressure signal Spo is fed back to the input signal Sin. In addition to the effects of the first embodiment, therefore, distortion (nonlinearity) contained in the whole system including the sound pressure signal Spo can be suppressed, and consequently distortion of the radiated sound can be decreased.

Therefore, the frequency characteristic in a small-sized speaker apparatus of phase inversion type can be improved efficiently.

(IV) Third Embodiment

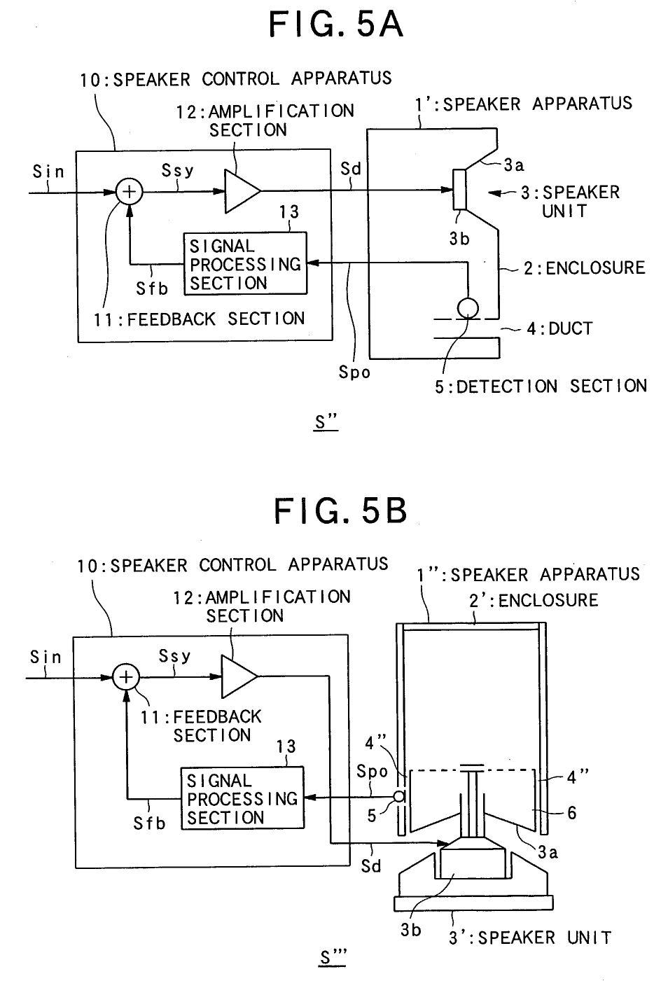

A third embodiment according to the present invention will now be described with reference to FIG. 5.

FIG. 5 is a block diagram showing a schematic configuration of a speaker system according to the third embodiment.

In the first and second embodiments, the case where the sound pressure within the enclosure 2 is detected by the detection section 5 has been described. In the third embodiment described hereafter, the sound pressure within the duct included in the speaker apparatus of bass-reflex type is detected and fed back.

In a speaker system S″ of the third embodiment, the detection section 5 is disposed in such a position that the sound pressure in air traveling in a duct 4′ included in a speaker apparatus 1′ as shown in FIG. 5A, and the detection section 5 detects the sound pressure, generates a corresponding sound pressure signal Spo, and outputs the sound pressure signal Spo to the speaker control apparatus 10.

The speaker control apparatus 10 having a configuration similar to that in the first embodiment conducts one of acceleration negative feedback processing, velocity negative feedback processing, or amplitude positive feedback processing, which are similar to those of the first embodiment, on the basis of the sound pressure signal Spo, generates the driving signal Sd, and outputs the driving signal Sd to the speaker unit 3.

A basic equation for obtaining the sound pressure P in the speaker system S″ of the third embodiment becomes the following equation.

$$\begin{matrix}P = \frac{ρ ω}{4 π r} \times \frac{( 1 - {Y}^{′} ) ( Ei + Ef ) \times BL \times S}{Rv \{ j ω ( mo + {Y}^{′} m p ) - \frac{j}{ω cs} + {BL}^{2} / Rv + rm + {Y}^{′} r p \}} \\ where {Y}^{′} = \frac{1}{j ω c c \times r p + 1 - {ω}^{2} \times m p \times c c}\end{matrix} \qquad ( 8 )$$

Definition of each of components in the equation (8) is the same as that in the first embodiment.

In the case where a sound pressure signal Spo corresponding to the sound pressure detected in the duct 4′ is subject to acceleration negative feedback, the equation (8) becomes as follows.

$$P = \frac{ρ ω}{4 π r} \times \frac{( 1 - {Y}^{′} ) Ei \times BL \times S}{Rv ( j ω \{ mo + {Y}^{′} ( m p + \frac{KBL}{Rv} ) \} - \frac{j}{ω cs} + {BL}^{2} / Rv + rm + {Y}^{′} r p )} \qquad ( 9 )$$

It will be appreciated from the equation (9) that the acceleration negative feedback is equivalent to an increase in the value of mass (kg) of air in the duct 4′ by “KBL/Rv” and consequently the frequency characteristic of the low frequency band at the sound pressure P is improved.

Therefore, the frequency characteristic in a small-sized speaker apparatus of phase inversion type can be improved efficiently.

The configuration of the third embodiment can also be applied to the velocity negative feedback processing or the amplitude positive feedback processing.

The configuration of the third embodiment can be applied to a speaker apparatus 1″ of bass-reflex type as shown in FIG. 5B. In FIG. 5B, a cylinder portion 6 having a diaphragm 3a in an opening portion thereof is disposed inside an enclosure 2′ so as to form a gap between the enclosure 2′ and the cylinder portion 6. The gap is used as a duct 4″.

In this case, the detection section 5 is disposed in such a position in the duct 4″ serving as the gap that the sound pressure can be detected as shown in FIG. 5B.

In the embodiments described above, the case where the present invention is applied to a speaker apparatus of bass-reflex type has been described. Besides this, however, the present invention can also be applied to the case where the frequency characteristic in a speaker apparatus of phase inversion type using the so-called passive corn.

In addition, the speaker control apparatus 10 or 10′ in the embodiments described above can also be formed of a digital circuit. And in this case, it becomes possible to conduct the so-called filtering processing for eliminating unnecessary band portions in the frequency component and the so-called equalizing processing for correcting the peculiar frequency characteristic for each of the speaker apparatuses 1, 1′ and 1″, with high precision. By forming the amplification section 12 of a digital amplifier (D class amplifier), it becomes possible to reduce the size of the speaker control apparatus 10 or 10′ including the amplification section 12.

In the case where the speaker control apparatus 10 or 10′ is separated from the speaker apparatus 1, 1′ or 1″ and disposed at a long distance from the speaker apparatus 1, 1′ or 1″, lines for connecting them becomes long and consequently the lines are apt to be affected by external noise. In this case as well, however, the influence of the external noise can be minimized by digitizing the sound pressure signal Spo and transmitting the digitized sound pressure signal Spo to the speaker control apparatus 10 or 10′.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2002-61536 filed on Mar. 7, 2002 including the specification, claims, drawings and summary is incorporated herein by reference in its entirety.

What is claimed is:

1. A speaker control apparatus comprising:
a single sound pressure detection device for detecting sound pressure in a speaker apparatus of phase inversion type and generating a sound pressure signal corresponding to the detected sound pressure;
a generation device for generating a feedback signal for feedback on the basis of the generated sound pressure signal;
a feedback device for feeding back the generated feedback signal to an input signal corresponding to sound to be radiated and generating a feedback input signal; and
a driving device for driving a speaker included in the speaker apparatus on the basis of the feedback input signal.

2. The speaker control apparatus according to claim 1, wherein
the sound pressure detection device detects sound pressure inside an enclosure included in the speaker apparatus, and generates the sound pressure signal corresponding to the detected sound pressure,
the generation device outputs the sound pressure signal intactly as the feedback signal, and
the feedback device conducts positive feedback of the output sound pressure signal to the input signal and generates the feedback input signal.

3. The speaker control apparatus according to claim 1, wherein
the sound pressure detection device detects sound pressure inside an enclosure included in the speaker apparatus, and generates the sound pressure signal corresponding to the detected sound pressure,
the generation device generates a differential sound pressure signal by differentiating the sound pressure signal, and outputs the generated differential sound pressure signal as the feedback signal, and
the feedback device conducts feedback of the output differential sound pressure signal to the input signal and generates the feedback input signal.

4. The speaker control apparatus according to claim 3, wherein
the generation device generates the differential sound pressure signal by differentiating the sound pressure signal once, and outputs the generated differential sound pressure signal as the feedback signal.

5. The speaker control apparatus according to claim 3, wherein
the generation device generates the differential sound pressure signal by differentiating the sound pressure signal twice, and
the feedback device conducts negative feedback of the generated differential sound pressure signal to the input signal and generates the feedback input signal.

6. The speaker control apparatus according to claim 1, wherein
the sound pressure detection device detects sound pressure inside an enclosure included in the speaker apparatus, and generates the sound pressure signal corresponding to the detected sound pressure,
the sound pressure detection device comprises:
a difference device for detecting a difference between the sound pressure signal and the input signal, and generating a difference signal;
a multiplication device for multiplying the difference signal by a preset feedback factor and generating a feedback difference signal; and
an addition device for adding the generated feedback difference signal to the sound pressure signal and generating a addition sound pressure signal serving as the feedback signal, and
the feedback device conducts positive feedback of the generated addition sound pressure signal to the input signal and generates the feedback input signal.

7. The speaker control apparatus according to claim 1, wherein
the sound pressure detection device detects sound pressure within a duct included in the speaker apparatus, and generates the sound pressure signal corresponding to the detected sound pressure, and
the generation device generates a differential sound pressure signal by differentiating the sound pressure signal, and outputs the generated differential sound pressure signal as the feedback signal.

8. The speaker control apparatus according to claim 7, wherein
the generation device generates the differential sound pressure signal by differentiating the sound pressure signal once.

9. The speaker control apparatus according to claim 7, wherein
the generation device generates the differential sound pressure signal by differentiating the sound pressure signal twice, and
the feedback device conducts negative feedback of the generated differential sound pressure signal to the input signal and generates the feedback input signal.

10. A speaker system comprising:
A speaker control apparatus including:
a single sound pressure detection device for detecting sound pressure in a speaker apparatus of phase inversion type and generating a sound pressure signal corresponding to the detected sound pressure;
a generation device for generating a feedback signal for feedback on the basis of the generated sound pressure signal;
a feedback device for feeding back the generated feedback signal to an input signal corresponding to sound to be radiated and generating a feedback input signal;
a driving device for driving a speaker included in the speaker apparatus on the basis of the feedback input signal; and
the speaker apparatus.
